(19) United States
(12) Patent Application Publication
(10) Pub. No.: US 2014/0189057 A1
(43) Pub. Date: Jul. 3, 2014

(54) DISTRIBUTION SYSTEM, DISTRIBUTION METHOD, AND RECORDING MEDIUM

(71) Applicant: FUJITSU LIMITED, Kawasaki-shi (JP)

(72) Inventors: Satoru SANKODA, Kawasaki (JP); Yuu Kumanomidou, Kawasaki (JP); Masashi Kamijyo, Naka (JP); Hiroshi Watanabe, Kawasaki (JP); Yukio Osada, Setagaya (JP)

(73) Assignee: FUJITSU LIMITED, Kawasaki-shi (JP)

(21) Appl. No.: 14/105,996

(22) Filed: Dec. 13, 2013

(30) Foreign Application Priority Data
Dec. 28, 2012 (JP) 2012-287790

(51) Int. Cl. H04L 29/08

(52) U.S. Cl. CPC H04L 67/10
USPC 709/217

(57) ABSTRACT

A distribution method includes: receiving, by a relay device that is provided within the certain segment, a distribution request that is used to receive image information that includes a file structure having one or more files such that the image information is divided into a plurality of pieces, from a distribution destination device that is provided within a certain segment in a communication network; transferring, by the relay device, the distribution request to a distribution source device that is provided outside the certain segment; transmitting, by the distribution source device, each divided pieces of the image information to the relay device in response to the distribution request; and receiving, by the relay device, each divided pieces of the image information from the distribution source device and transferring each divided pieces of the image information to the distribution destination device.

### CROSS-REFERENCE TO RELATED APPLICATION

This application is based upon and claims the benefit of priority from the prior Japanese Patent Application No. 2012-287790 filed on Dec. 28, 2012, the entire contents of which are incorporated herein by reference.

### FIELD

The embodiments discussed herein are related to a distribution system, a distribution method, and a recording medium.

### BACKGROUND

When a system that has a disk content similar to that of an information processing device (computer) serving as a master device is to be built on another information processing device being a similar model to the information processing device, a disk image is distributed to the another information processing device. In addition, the disk image is copied to a hard disk of the another information processing device, and the system that is similar to the master device is built. The disk image is image information that indicates the disk content of the master device, and includes information on one or more files that are stored in the master device and information on a file structure of a file system that manages the files.

FIG. 1 illustrates a configuration example of a distribution system in the related art, which distributes a disk image. The distribution system in FIG. 1 includes a master device 101, a distribution source device 102, and distribution destination devices 103-1 to 103-3. The master device 101, the distribution source device 102, and the distribution destination devices 103-1 to 103-3 are coupled to each other through a communication network 111. In a description that is made below, one or more of the distribution destination devices 103-1 to 103-3 may be referred to as a distribution destination device 103 or distribution destination devices 103.

The master device 101 is an information processing device that has a base image of a disk image to be distributed, and each of the distribution destination devices 103-1 to 103-3 is an information processing device the model of which is similar to that of the master device 101. The distribution source device 102 is an information processing device that distributes the disk image of the master device 101 to the distribution destination devices 103-1 to 103-3 through the communication network 111. Each of the distribution destination devices 103-1 to 103-3 builds a system into the respective hard disk by writing the distributed disk image.

In such a distribution system, the disk image of the master device 101 may be distributed and copied to the distribution destination devices 103 without changing the configuration of the disk image of the master device 101, so that a system having the similar disk content may be built in a short time. Therefore, when the systems are built on the plurality of distribution destination devices 103 not on a single device, the distribution for all devices may be performed at one time within as short as a distribution for one device, so that effort and times that are taken when an operating system (OS) and an application program (AP) are installed are greatly reduced.

As the related art, a data processing method is known in which a coupling state of a client device to a home network and computational resources of the whole network are managed by a private server. In such a data processing method, when a download request is issued from the client device to the private server, data or a program on the public server is downloaded to the private server and stored in a hard disk area of the private server, which is an area to be used by the client device. In addition, the client device may use the data or program that has been downloaded to the private server.

As the related art, a method for secure network installation is also known. In such a method, a proxy server in a subnet in which a client also exists downloads a boot image file from a boot file server in a secure way. In addition, the client downloads the boot image file from the proxy server.

As examples of the related art, Japanese Laid-open Patent Publication No. 2002-297559 and Japanese National Publication of International Patent Application No. 2009-501986 are known.

### SUMMARY

According to an aspect of the invention, a distribution system includes: a distribution destination device that includes a first processor and is provided within a certain segment in a communication network; a distribution source device that includes a second processor and is provided outside the certain segment; and a relay device that includes a third processor and is provided within the certain segment. The first processor of the distribution destination device transmits a distribution request that is used to receive image information that includes a file structure having one or more files such that the image information is divided into a plurality of pieces. The second processor of the distribution source device transmits each of the plurality of divided pieces of the image information in response to the distribution request. The third processor of the relay device transfers the distribution request from the distribution destination device to the distribution source device and transfers each of the plurality of divided pieces of the image information from the distribution source device to the distribution destination device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram of a distribution system in the related art;

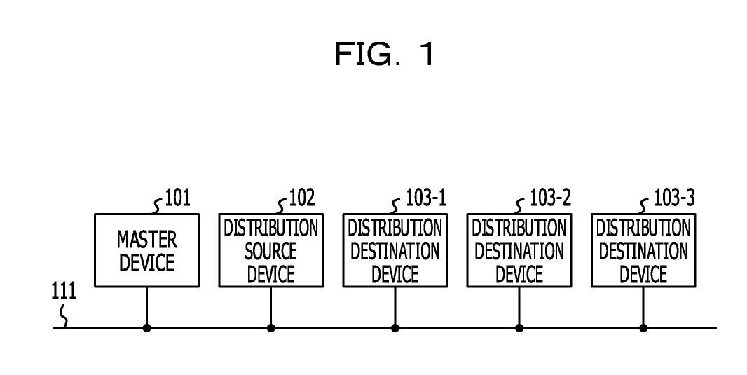

FIG. 2 is a configuration diagram illustrating a first distribution system;

FIG. 3 is a configuration diagram illustrating a second distribution system;

FIG. 4 is a configuration diagram illustrating a third distribution system;

FIG. 5 is a configuration diagram illustrating a fourth distribution system;

FIG. 6 is a configuration diagram illustrating a distribution system according to an embodiment;

FIG. 7 is a diagram illustrating information that is stored in a distribution source device;

FIG. 8 is a diagram illustrating a distribution sequence;

FIG. 9 is a diagram illustrating the detailed distribution sequence;

FIG. 10 is a diagram illustrating the detailed distribution sequence;

FIG. 11 is a flowchart illustrating an operation that is executed by a relay device;

FIG. 12 is a flowchart illustrating the operation that is executed by the relay device;

FIG. 13 is a flowchart illustrating an operation that is executed by a distribution destination device;

FIG. 14 is a flowchart illustrating the operation that is executed by the distribution destination device;

FIG. 15 is a flowchart illustrating the operation that is executed by the distribution destination device;

FIG. 16 is a diagram illustrating an IP address;

FIG. 17 is a diagram illustrating a case in which distribution to a single distribution destination device is performed;

FIG. 18 is a diagram illustrating a distribution time that is taken when distribution to a single distribution destination device is performed;

FIG. 19 is a diagram illustrating a case in which distribution to ten distribution destination devices is performed;

FIG. 20 is a diagram illustrating a distribution time that is taken when distribution to ten distribution destination devices is performed; and

FIG. 21 is a configuration diagram illustrating an information processing device.

### DESCRIPTION OF EMBODIMENTS

In the distribution system in the related art, the system having the similar disk content may be built in a short time. However, the distribution system in the related art has the following problems.

When the communication network includes a wide area network (WAN) and a plurality of segments, a connection device such as a router and a firewall is provided in a boundary between each of the segments and the WAN in many cases. In addition, it is very difficult for the distribution destination device to use a communication protocol that is used to communicate with an information processing device in another segment through the WAN across the connection device in the boundary of the segment because an OS is not installed in the distribution destination device yet.

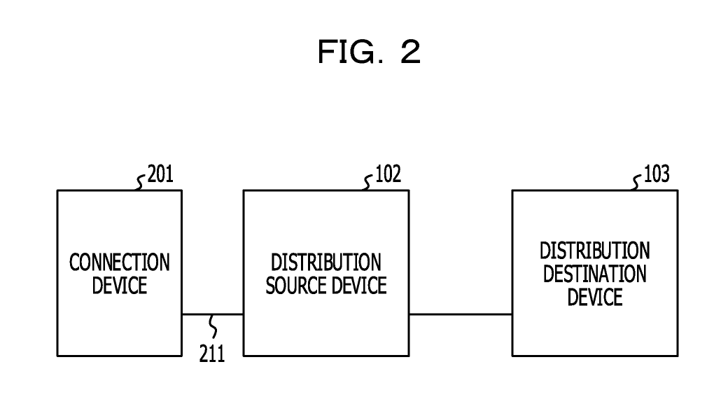

Therefore, as illustrated in FIG. 2, the distribution source device 102 and the distribution destination devices 103 are provided in the same segment 211 in which a connection device 201 is used as a boundary, and a disk image is distributed from the distribution source device 102 to the distribution destination devices 103 in the segment 211.

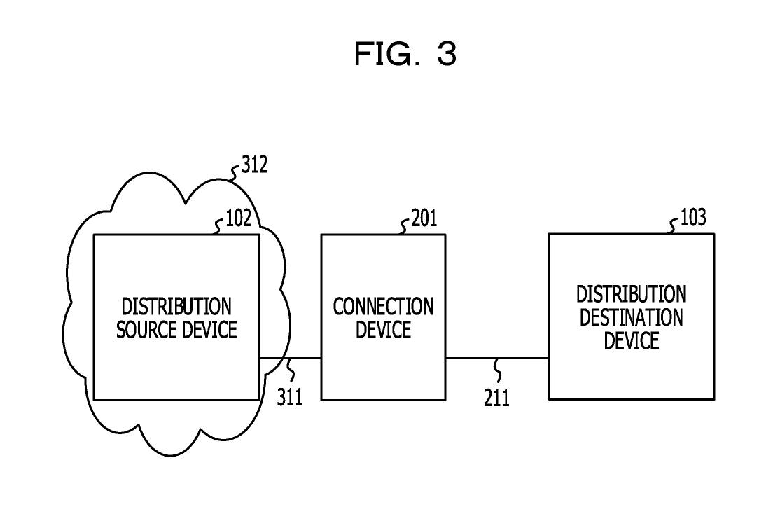

In addition, as illustrated in FIG. 3, a distribution system is assumed in which a WAN 311 and the segment 211 are segmented using the connection device 201 as the boundary, the distribution source device 102 is provided on the WAN 311 side, and the distribution destination devices 103 is provided in the segment 211. In FIG. 3, the segment 211 is, for example, a local area network (LAN) and constitutes a corporate intranet. In addition, the WAN 311 is, for example, the Internet, and constitutes a software as a service (SaaS) type public cloud 312. The distribution source device 102 is provided in another segment in the public cloud 312.

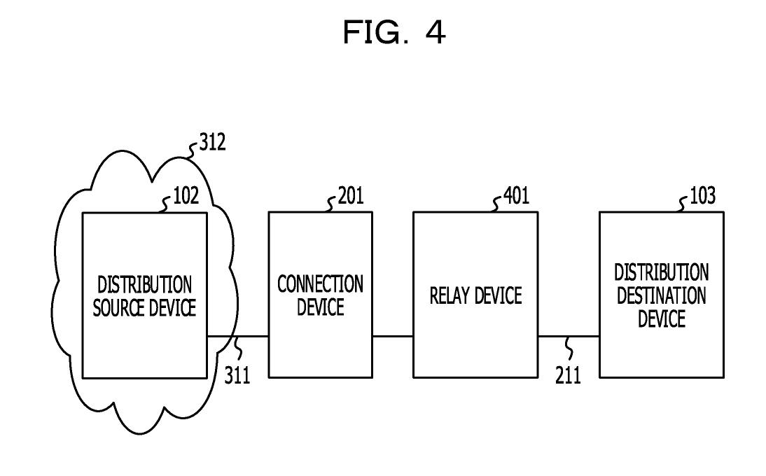

In the distribution system in FIG. 3, because it is difficult for the distribution destination devices 103 to communicate with the distribution source device 102 across the connection device 201, as illustrated in FIG. 4, it is desirable that a relay device 401 is provided in the segment 211. An OS is installed in the relay device 401, and the relay device 401 may use a communication protocol that is used to communicate with the distribution source device 102 in the public cloud 312 across the connection device 201.

As the distribution method in the distribution system in FIG. 4, a method is conceivable in which the relay device 401 downloads a disk image from the distribution source device 102 once and distributes the disk image to the distribution destination device 103 through the segment 211. In this case, the relay device 401 stores the downloaded disk image in a hard disk once, reads the disk image from the hard disk and distributes the disk image to the distribution destination device 103.

However, in such a distribution method, until download of the disk image from the distribution source device 102 to the relay device 401 is completed, distribution of the disk image from the relay device 401 to the distribution destination devices 103 is not started. Therefore, it takes a long time to distribute the disk image as compared with a case in which a disk image is directly distributed from the distribution source device 102 to the distribution destination devices 103 in the same segment.

Such a problem is not limited to a case in which image information as a disk image is distributed, and occurs even in a case in which image information that is a storage content of a recording medium other than a disk is distributed.

Therefore, it is desirable that image information is distributed from the distribution source device 102 that is provided outside the segment, to the distribution destination devices 103 in the segment at a higher speed. In a description that is made below, the image information may be simply referred to as an image.

The embodiments are described below in detail with reference to drawings.

It is conceivable that a speed at which the distribution destination devices 103 writes a disk image into a hard disk is slower than a speed at which the disk image is transferred from the relay device 401 to the distribution destination devices 103. Therefore, the distribution destination devices 103 may not receive the whole disk image at the time of start of writing. Therefore, the relay device 401 may not download the whole disk image at once, and may not also transfer the disk image to the distribution destination devices 103 at a high speed in the segment 211.

In this case, the writing performance is not reduced even when the disk image is divided into a plurality of pieces, and each of the pieces is transmitted from the distribution source device 102 to the relay device 401 and transferred to the distribution destination devices 103 successively each time the relay device 401 receives each of the pieces of the disk image.

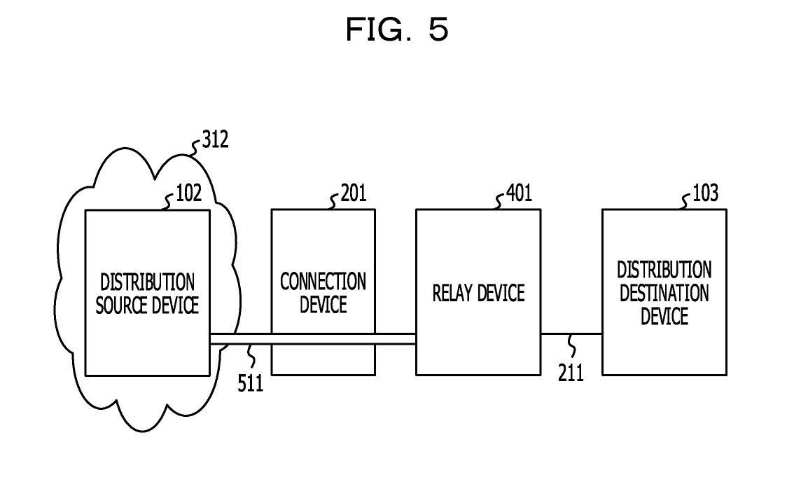

When such a distribution method is employed, for example, as illustrated in FIG. 5, a tunnel 511 may be provided between the distribution source device 102 and the relay device 401. The relay device 401 capsulates communication from the distribution destination devices 103 to the distribution source device 102 using the tunnel 511 and transfers the pieces of the disk image that are received from the distribution source device 102, to the distribution destination devices 103. As the communication protocol using the tunnel 511, for example, a communication protocol such as a secure socket layer virtual private network (SSL-VPN), which does not desire setting of the connection device 201 may be used.

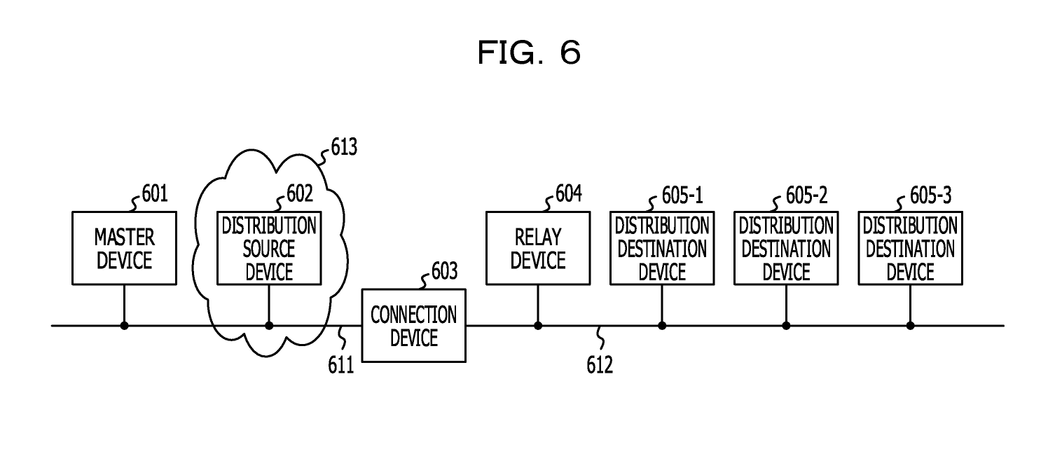

FIG. 6 is a configuration diagram of a distribution system according to an embodiment that distributes an image. The distribution system in FIG. 6 includes a master device 601, a distribution source device 602, a connection device 603, a relay device 604, and distribution destination devices 605-1 to 605-3.

The distribution source device 602 is provided in a public cloud 613 that is constituted by a WAN 611 that is provided outside a segment 612, and the relay device 604 and the distribution destination devices 605-1 to 605-3 are provided in the segment 612. The master device 601 may be provided in the public cloud 613 and may be provided in a segment that is different from the segment 612. The connection device 603 is provided in the boundary between the WAN 611 and the segment 612. The segment 612 corresponds to, for example, a subnet in which the distribution destination devices 605-1 to 605-3 are provided.

In a description that is made below, one or more of the distribution destination devices 605-1 to 605-3 may be referred to as a distribution destination device 605 or distribution destination devices 605. The number of the distribution destination devices 605 in the segment 612 is not limited to three as long as the number is an integer of one or more.

The master device 601 includes a recording medium such as a magnetic disk, an optical disk, a magneto optical disk, or a tape, and one or more files are stored in the recording medium. A hard disk is included in the magnetic disk. Image information that includes a file structure of the one or more files in the recording medium of the master device 601 is stored in the distribution source device 602 before distribution.

The relay device 604 causes the distribution destination devices 605 to be started up, and the distribution destination devices 605 transmit a plurality of distribution requests that are used to receive image information so that the image information is divided into a plurality of pieces, to the relay device 604. The relay device 604 transfers the plurality of distribution requests that are received from the distribution destination devices 605, to the distribution source device 602.

The distribution source device 602 transmits one piece among the plurality of pieces of the image information to the relay device 604 in response to one distribution request among the plurality of distribution requests that are received from the relay device 604. In addition, the relay device 604 receives the one piece of the image information from the distribution source device 602 and transfers the piece to the distribution destination device 605.

In such a distribution system, the image information may be distributed from the distribution source device 602 that is provided outside the segment 612 to the distribution destination device 605 in the segment 612 at a higher speed.

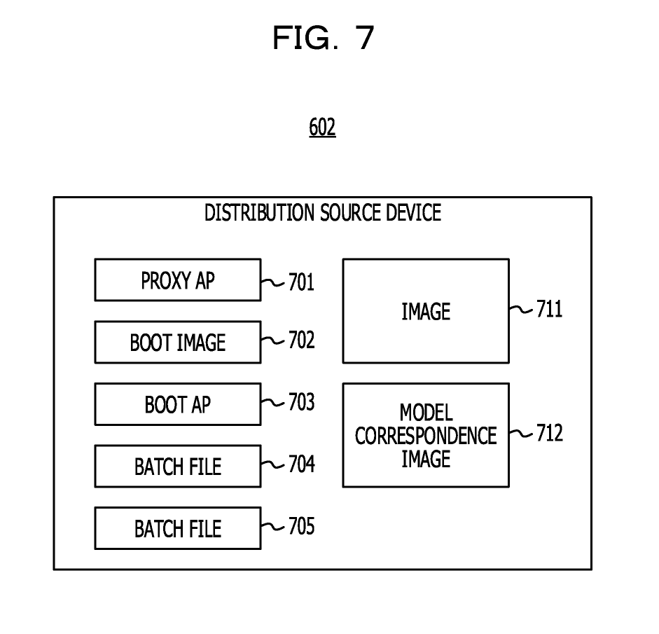

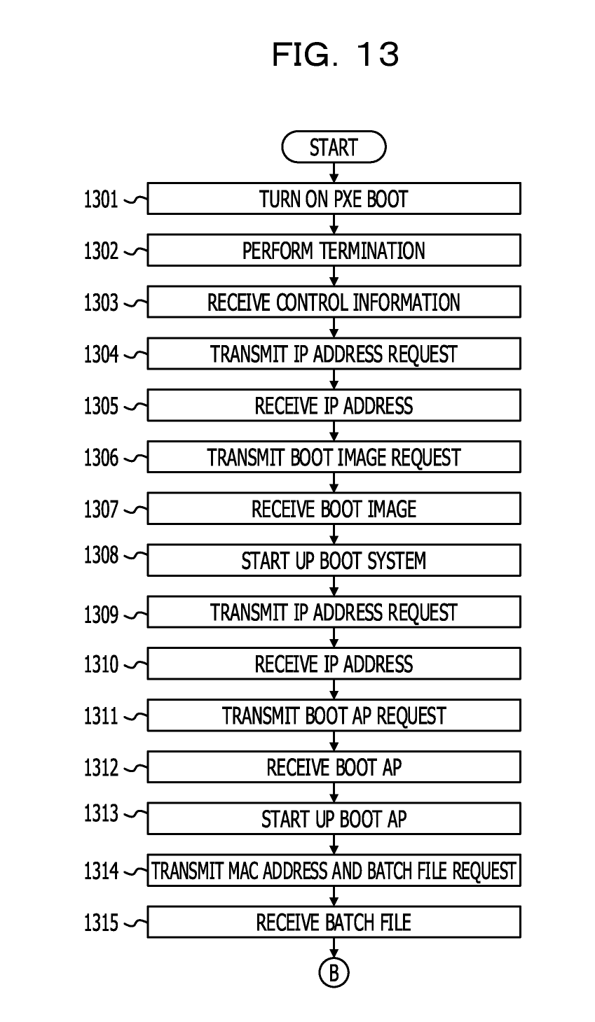

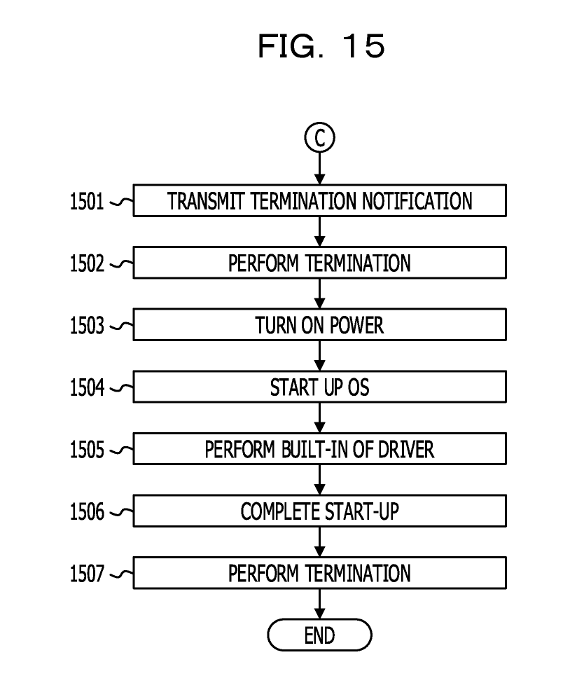

An operation of the distribution system in FIG. 6 is described in detail below with reference to FIGS. 7 to 16.

FIG. 7 is a diagram illustrating an example of information that is stored in the distribution source device 602 in FIG. 6. The distribution source device 602 in FIG. 7 stores a proxy AP 701, a boot image 702, a boot AP 703, a batch file 704, a batch file 705, an image 711, and a model correspondence image 712.

The proxy AP 701 is a program that is downloaded and executed by the relay device 604. The boot image 702 is an image file that includes a file of a boot system that is an OS that operates on a memory of the distribution destination device 605, and is transferred to the distribution destination device 605 through the relay device 604. The boot AP 703 is an AP that operates on the boot system and is transferred to the distribution destination device 605 through the relay device 604.

The image 711 is an image file that includes a file structure of one or more files in the recording medium of the master device 601 and is distributed to the distribution destination device 605 through the relay device 604. The model correspondence image 712 is an image file that is distributed to the distribution destination device 605 in addition to the image 711 when the model of the distribution destination device 605 is different from the model of the master device 601. The model correspondence images 712 are prepared in an equal amount to the number of models that are different from that of the master device 601.

A case in which the model of the distribution destination device 605 is different from the model of the master device 601 is a case in which it is desirable that a device driver or the like that is different from the master device 601 is used because the distribution destination device 605 includes a device the specification of which is different from that of the master device 601. In the model correspondence image 712, for example, one or plurality of files among files the model dependences of which are high, such as a device driver, a kernel, and a hardware abstraction layer (HAL) are included.

The batch file 704 is a file in which a process is described in which the distribution destination device 605 receives the image 711 so that the image 711 is divided into a plurality of pieces, and writes the pieces to the recording medium of the distribution destination device 605, and is transferred to the distribution destination device 605 through the relay device 604. As the recording medium of the distribution destination device 605, a magnetic disk, an optical disk, a magneto optical disk, or the like may be used. The batch file 705 is a file in which a process is described in which the distribution destination device 605 receives the model correspondence image 712 and writes the model correspondence image 712 to the recording medium of the distribution destination device 605, and is transferred to the distribution destination device 605 through the relay device 604.

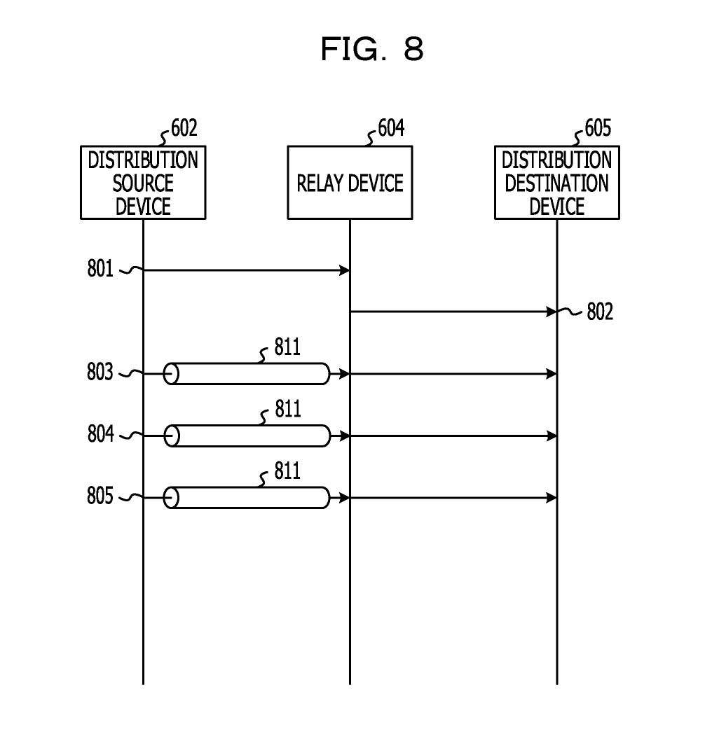

FIG. 8 is a diagram illustrating a distribution sequence in the distribution system in FIG. 6. In FIG. 8, the single distribution destination device 605 is illustrated, however, a plurality of distribution destination devices 605 may be applied.

The relay device 604 downloads the proxy AP 701 from the distribution source device 602 first (process 801), executes the proxy AP 701, and executes processing of processes 802 to 805.

The relay device 604 causes the distribution destination device 605 to be started up (process 802), receives the boot image 702 and the boot AP 703 from the distribution source device 602 through a tunnel 811, and transfers the boot image 702 and the boot AP 703 to the distribution destination device 605 (process 803). Therefore, the boot system is started up on the memory of the distribution destination device 605, and the boot AP 703 operates.

As a communication protocol of the tunnel 811, for example, a SSL-VPN may be used. However, when information that is transmitted and received through the tunnel 811 is not desired to be encrypted, another non-encrypted communication protocol may be used.

After that, the relay device 604 receives the image 711 from the distribution source device 602 through the tunnel 811 so that the image 711 is divided into the plurality of pieces (process 804). In addition, the relay device 604 transfers the received piece of the image 711 to the distribution destination device 605 each time the relay device 604 receives the piece of the image 711. The operation to receive and transfer the piece of the image 711 is repeated until transfer of the whole image to the distribution destination device 605 is completed.

After that, the relay device 604 receives the model correspondence image 712 from the distribution source device 602 through the tunnel 811 and transfers the received model correspondence image 712 to the distribution destination device 605 (process 805).

When the model of the distribution destination device 605 is different from the model of the master device 601, there is a case in which a file the model dependence of which is high and that is included in the image 711 is not compatible with the specification of the distribution destination device 605. Therefore, the OS may be started up on the distribution destination device 605 not merely with the image 711. Thus, the OS may be started up on the distribution destination device 605 by distributing the model correspondence image 712 from the distribution source device 602 to the distribution destination device 605.

When the model of the distribution destination device 605 is similar to the model of the master device 601, the process 805 may be omitted.

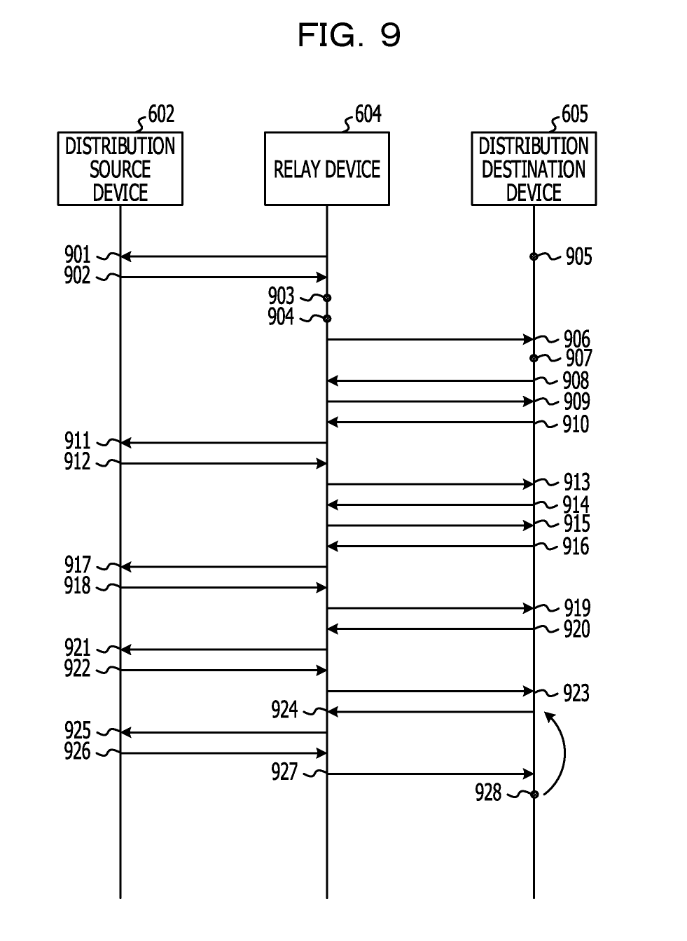

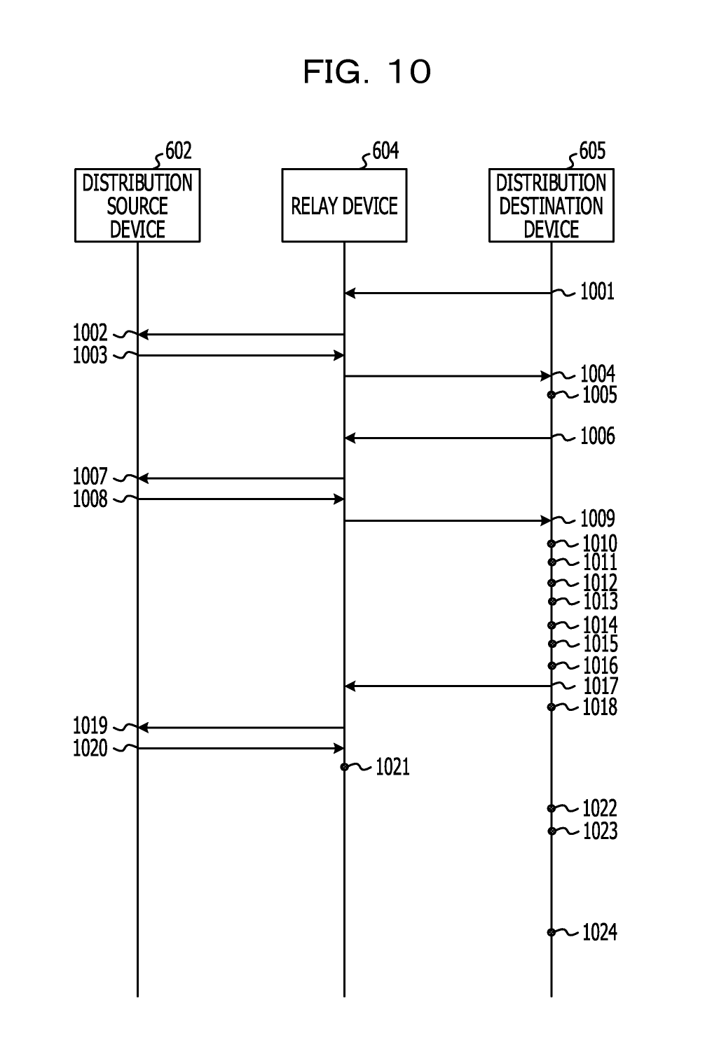

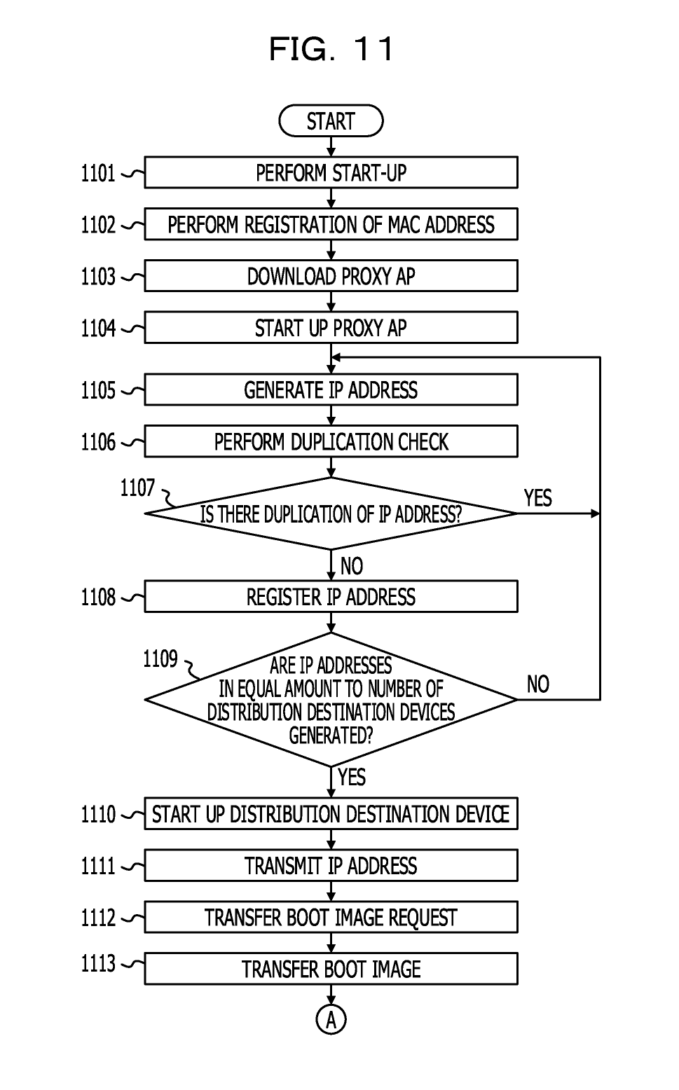

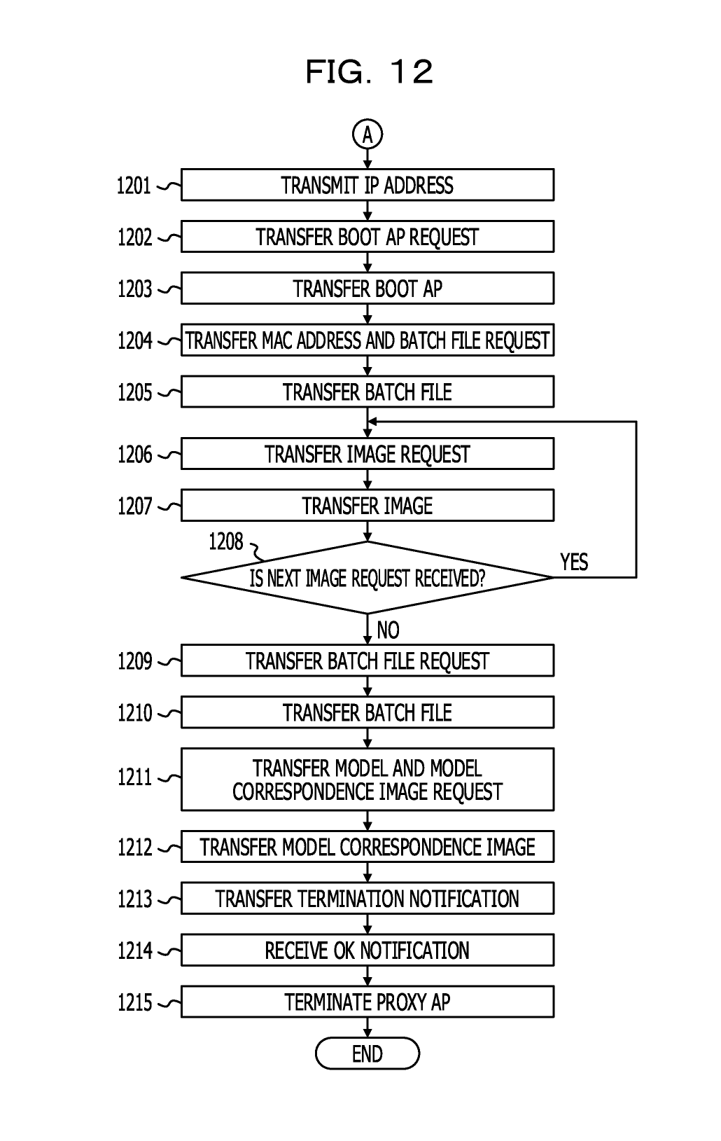

FIGS. 9 and 10 are illustrating examples in which the distribution sequence in FIG. 8 is further detailed. FIGS. 11 and 12 are flowcharts of an operation that is executed by the relay device 604 in the distribution sequence in FIGS. 9 and 10, and FIGS. 13 to 15 are flowcharts of an operation that is executed by the distribution destination device 605 in the distribution sequence in FIGS. 9 and 10. In FIGS. 9 and 10, the single distribution destination device 605 is illustrated, however, a plurality of distribution destination devices 605 may be applied.

First, an operator starts up a web browser of the relay device 604 and accesses the distribution source device 602 using the web browser (process 901, Step 1101). At that time, the relay device 604 may access, for example, the distribution source device 602 using a hypertext transfer protocol over secure socket layer (HTTPS). In addition, the operator inputs a media access control (MAC) address of the distribution destination device 605 to the web browser, and the relay device 604 transmits the MAC address to the distribution source device 602 (Step 1102). Therefore, the MAC address of the distribution destination device 605 is registered to the distribution source device 602.

After that, the operator downloads the proxy AP 701 from the distribution source device 602 to the relay device 604 (process 902, Step 1103). At that time, the relay device 604 may download the proxy AP 701 from the distribution source device 602, for example, using the HTTPS. The proxy AP 701 includes a file to which the MAC address of the distribution destination device 605, which is registered to the distribution source device 602 is recorded.

After that, the relay device 604 causes the proxy AP 701 to be started up (process 903, Step 1104) and executes processing of processes 904 to 1020 (Steps 1105 to 1214).

The relay device 604 generates a candidate of an internet protocol (IP) address for the distribution destination device 605 using an IP address of the relay device 604 (process 904, Step 1105). At that time, the relay device 604 extracts a network address and a subnet address from the IP address of the relay device 604 and randomly generates a host address. In addition, the relay device 604 combines the extracted network address and subnet address with the generated host address to generate a candidate of the IP address.

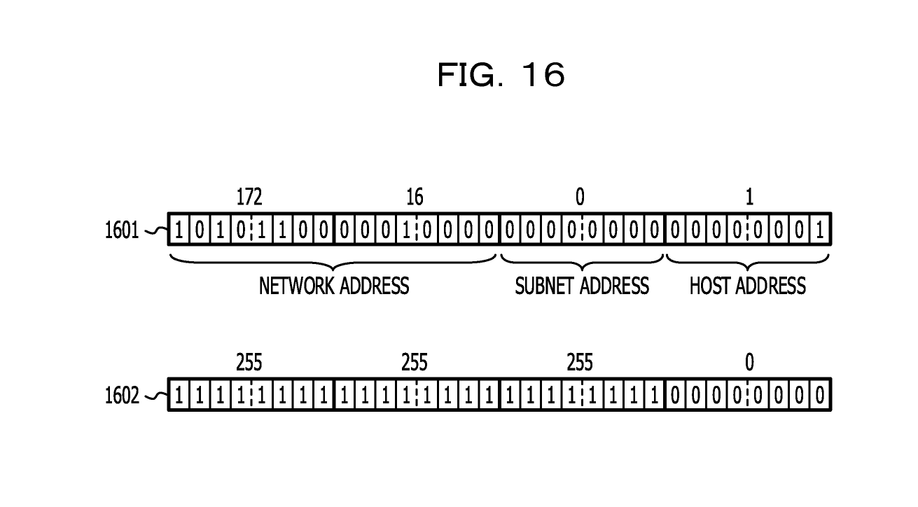

FIG. 16 is a diagram illustrating an example of a 32-bit IP address 1601. The IP address 1601 is constituted by a 16-bit network address, an 8-bit subnet address, and an 8-bit host address. When the IP address 1601 is an IP address of the relay device 604, the relay device 604 may extract a network address and a subnet address by obtaining a logical product of the IP address 1601 and a subnet mask 1602.

In addition, the relay device 604 may generate a candidate of the 32-bit IP address by generating an 8-bit host address randomly and combining the extracted 16-bit network address and 8-bit subnet address.

The bit numbers of the IP address 1601 and the subnet mask 1602 are not limited to 32-bit, and may be another bit number. In addition, the bit numbers of the network address, the subnet address, and the host address may be another bit number.

The operator checks a MAC address of the distribution destination device 605 and turns on preboot execution environment (PXE) boot setting of a basic input/output system (BIOS) in the distribution destination device 605 (process 905, Step 1301). In addition, the operator terminates the distribution destination device 605 as is (shuts down the distribution destination device 605) (Step 1302). Therefore, the distribution destination device 605 becomes in a state of being allowed to be started up through the communication network of the segment 612.

After that, the relay device 604 performs duplication check on the IP addresses (Step 1106), and determines whether an IP address that is the same as the candidate of the generated IP address exists in the segment 612 (Step 1107). At that time, the relay device 604 may determine that the IP address that is the same as the candidate of the generated IP address does not exist in the segment 612 by transmitting an internet control message protocol (ICMP) echo request to the generated IP address.

When the IP address that is the same as the candidate of the generated IP address exists in the segment 612 (YES in Step 1107), the relay device 604 repeats the processing in Step 1105 and the subsequent steps. In addition, when the IP address that is the same as the candidate of the generated IP address does not exist in the segment 612 (NO in Step 1107), the relay device 604 registers the candidate of the generated IP address to the memory (Step 1108).

After that, the relay device 604 checks whether candidates of the IP address in an equal amount to the number of the distribution destination devices 605 are generated (Step 1109), and when the number of candidates of the IP address is lacking (NO in Step 1109), the processing in Step 1105 and subsequent steps is repeated. Therefore, the candidates of the IP address in an equal amount to the number of the distribution destination devices 605 are registered to the memory. When the relay device 604 automatically generates candidates of the IP address and performs duplication check on the IP addresses, the operator may not perform setting so that the candidates of the IP address are not duplicated.

When the candidates of the IP address in an equal amount to the number of the distribution destination devices 605 are generated (YES in Step 1109), the relay device 604 causes the distribution destination device 605 to be started up through the communication network of the segment 612 (process 906, Step 1110).

At that time, the relay device 604 transmits control information such as a wake on LAN (WOL) magic packet to the MAC address of the distribution destination device 605, which is registered to the file of the proxy AP 701, for example, using a user datagram protocol (UDP). The distribution destination device 605 may be started up by transmitting the control information such as WOL magic packet.

The distribution destination device 605 receives the control information from the relay device 604 and starts up the control information (process 907, Step 1303) and transmits an IP address request to the relay device 604 (process 908, Step 1304). At that time, the BIOS in the distribution destination device 605 may broadcast the IP address request on the communication network of the segment 612, for example, using a dynamic host configuration protocol (DHCP).

The relay device 604 monitors an IP address request in the segment 612, and when the relay device 604 receives an IP address request, the relay device 604 selects one of the candidates of the IP address, which are registered to the memory and transmits the candidate to the distribution destination device 605 (process 909, Step 1111). At that time, the relay device 604 may transmit the candidate of the IP address to the distribution destination device 605, for example, using the DHCP.

The BIOS in the distribution destination device 605 registers the IP address that is received from the relay device 604 (Step 1305). Therefore, the IP address is assigned to the distribution destination device 605, and the distribution destination device 605 may perform communication using the IP address.

After that, the relay device 604 may relay communication between the distribution source device 602 and the distribution destination device 605 across the connection device 603 by capsulating the communication through the tunnel 811. At that time, the relay device 604 may relay the communication without storing the communication data in a recording medium other than the memory by performing port listen and transfer on the memory.

The distribution destination device 605 transmits a boot image request to the relay device 604 (process 910, Step 1306), and the relay device 604 transfers the received boot image request to the distribution source device 602 (process 911, Step 1112). At that time, the distribution destination device 605 may transmit the boot image request to the relay device 604, for example, using a trivial file transfer protocol (TFTP). In addition, the relay device 604 may transfer the boot image request to the distribution source device 602, for example, using the TFTP.

The distribution source device 602 transmits the boot image 702 to the relay device 604 (process 912), and the relay device 604 transfers the received boot image 702 to the distribution destination device 605 (process 913, Step 1113). At that time, the distribution source device 602 may transmit the boot image 702 to the relay device 604, for example, using the TFTP. In addition, the relay device 604 may transfer the boot image 702 to the distribution destination device 605, for example, using the TFTP.

The distribution destination device 605 receives the boot image 702 from the relay device 604 (Step 1307), loads the boot image 702 on the memory, and causes a boot system to be started up (Step 1308). In addition, the distribution destination device 605 executes processing of processes 914 to 919 (Steps 1309 to 1313) by the boot system.

The distribution destination device 605 transmits an IP address request to the relay device 604 again (process 914, Step 1309). At that time, the distribution destination device 605 may broadcast the IP address request on the communication network of the segment 612, for example, using the DHCP.

When the relay device 604 receives the IP address request, the relay device 604 selects one of the candidates of the IP address, which are registered to the memory, and transfers the candidate to the distribution destination device 605 (process 915, Step 1201). At that time, the relay device 604 may transmit the candidate of the IP address to the distribution destination device 605, for example, using the DHCP. The distribution destination device 605 registers the IP address that is received from the relay device 604 (Step 1310).

When a plurality of candidates of an IP address are registered to the relay device 604, the candidate of the IP address, which is selected in the process 915 and the candidate of the IP address, which is selected in the process 909 may be the same and may be different.

After that, the distribution destination device 605 transmits a boot AP request to the relay device 604 (process 916, Step 1311), and the relay device 604 transfers the received boot AP request to the distribution source device 602 (process 917, Step 1202). At that time, the distribution destination device 605 may transmit the boot AP request to the relay device 604, for example, using the TFTP. In addition, the relay device 604 may transfer the boot AP request to the distribution source device 602, for example, using the TFTP.

The distribution source device 602 transmits the boot AP 703 to the relay device 604 (process 918), and the relay device 604 transfers the received boot AP 703 to the distribution destination device 605 (process 919, Step 1203). At that time, the distribution source device 602 may transmit the boot AP 703 to the relay device 604, for example, using the TFTP. In addition, the relay device 604 may transfer the boot AP 703 to the distribution destination device 605, for example, using the TFTP.

The distribution destination device 605 receives the boot AP 703 from the relay device 604 (Step 1312), loads the boot AP 703 on the memory, and causes the boot AP 703 to be started up (Step 1313). In addition, the distribution destination device 605 executes processing of processes 920 to 1018 (Steps 1314 to 1502) by the boot AP 703.

In the process 920, the process 923, the process 924, the process 927, the process 1001, the process 1004, the process 1006, the process 1009, and the process 1017, the relay device 604 and the distribution destination device 605 may communicate with each other, for example, using the UDP. In addition, in the process 921, the process 922, the process 925, the process 926, the process 1002, the process 1003, the process 1007, the process 1008, the process 1019, and the process 1020, the distribution source device 602 and the relay device 604 may communicate with each other, for example, using the UDP.

The distribution destination device 605 transmits a MAC address and a batch file request of the distribution destination device 605 to the relay device 604 (process 920, Step 1314). In addition, the relay device 604 transfers the received MAC address and batch file request to the distribution source device 602 (process 921, Step 1204).

The distribution source device 602 registers the received MAC address and transmits the batch file 704 to the relay device 604 (process 922). In addition, the relay device 604 transfers the received batch file 704 to the distribution destination device 605 (process 923, Step 1205).

The distribution destination device 605 receives the batch file 704 from the relay device 604 (Step 1315), executes the batch file 704, and executes processing of processes 924 to 928 (Steps 1401 to 1404).

In order to receive the image 711 so that the image 711 is divided into the plurality of pieces, the distribution destination device 605 transmits an image request to the relay device 604 (process 924, Step 1401), and the relay device 604 transfers the received image request to the distribution source device 602 (process 925, Step 1206).

The distribution source device 602 transmits the piece of the image 711 to the relay device 604 (process 926), and the relay device 604 transfers the received piece of the image 711 to the distribution destination device 605 (process 927, Step 1207). At that time, the relay device 604 may transfer the received piece of the image 711 to the distribution destination device 605 without storing the piece in the recording medium other than the memory. Therefore, the image 711 may be distributed to the distribution destination device 605 at a high speed as compared with the case in which the whole image 711 is downloaded from the distribution source device 602 to the relay device 604.

The distribution destination device 605 receives the piece of the image 711 from the relay device 604 (Step 1402) and writes the received piece of the image 711 to the recording medium of the distribution destination device 605 (process 928, Step 1403).

In addition, the distribution destination device 605 checks whether the whole the image 711 are written to the recording medium (Step 1404), and when the whole image 711 are not written to the recording medium yet (NO in Step 1404), the processing in Step 1401 and subsequent steps is repeated. In addition, the relay device 604 checks whether a next image request has been received from the distribution destination device 605 (Step 1208), and when the next image request has been received (YES in Step 1208), the processing in Step 1208 and subsequent steps is repeated.

Therefore, the image 711 is divided into the plurality of pieces and each of the pieces is distributed from the distribution source device 602 to the distribution destination device 605 and written to the recording medium of the distribution destination device 605. The distribution destination device 605 builds a system by writing the whole image 711 to the recording medium.

In addition, when the whole image 711 are written to the recording medium (YES in Step 1404), the distribution destination device 605 transmits the batch file request to the relay device 604 (process 1001, Step 1405).

When the relay device 604 receives the batch file request without receiving a next image request from the distribution destination device 605 (NO in Step 1208), the relay device 604 transfers the received batch file request to the distribution source device 602 (process 1002, Step 1209).

The distribution source device 602 transmits the batch file 705 to the relay device 604 (process 1003), and the relay device 604 transfers the received batch file 705 to the distribution destination device 605 (process 1004, Step 1210).

The distribution destination device 605 receives the batch file 705 from the relay device 604 (Step 1406), executes the batch file 705, and executes processing of processes 1005 to 1018 (Steps 1407 to 1502).

The distribution destination device 605 obtains information on a model from the BIOS in the distribution destination device 605 (process 1005, Step 1407) and transmits the model of the distribution destination device 605 and a model correspondence image request to the relay device 604 (process 1006, Step 1408). In addition, the relay device 604 transfers the received model and the model correspondence image request to the distribution source device 602 (process 1007, Step 1211).

The distribution source device 602 transmits the model correspondence image 712 that corresponds to the received model to the relay device 604 (process 1008), and the relay device 604 transfers the received model correspondence image 712 to the distribution destination device 605 (process 1009, Step 1212). Therefore, the model correspondence image 712 is distributed from the distribution source device 602 to the distribution destination device 605. In the distributed model correspondence image 712, for example, a device driver such as storage drivers and a plug and play (PNP) driver, a kernel, and a HAL are included.

The distribution destination device 605 receives the model correspondence image 712 from the relay device 604 (Step 1409) and loads the received model correspondence image 712 on the memory (process 1010, Step 1410).

After that, the distribution destination device 605 stores the storage driver that is included in the model correspondence image 712, in an appropriate location of the recording medium (process 1011, Step 1411). In addition, the distribution destination device 605 changes a registry in the recording medium so that the storage driver appropriately operates (process 1012, Step 1412).

After that, the distribution destination device 605 stores the kernel and the HAL that are included in the model correspondence image 712, in an appropriate location of the recording medium (process 1013, Step 1413). In addition, the distribution destination device 605 changes the boot setting in the recording medium (process 1014, Step 1414).

After that, the distribution destination device 605 stores the PNP driver that is included in the model correspondence image 712, in an appropriate location of the recording medium (process 1015, Step 1415). In addition, the distribution destination device 605 changes the registry in the recording medium so that the PNP driver appropriately operates (process 1016, Step 1416).

In addition, the distribution destination device 605 transmits termination notification that indicates termination of image writing, to the relay device 604 (process 1017, Step 1501), and performs the termination (performs the shutdown) (process 1018, Step 1502). The relay device 604 transfers the received termination notification to the distribution source device 602 (process 1019, Step 1213).

The distribution source device 602 transmits OK notification that responds to the termination notification, to the relay device 604 (process 1020). The relay device 604 receives the OK notification (Step 1214) and terminates the execution of the proxy AP 701 (process 1021, Step 1215).

After that, the distribution destination device 605 is started up through a power operation by the operator or the control information that is transmitted from the relay device 604 (process 1022, Step 1503) and causes the OS that is stored in the recording medium of the distribution destination device 605 to be started up (Step 1504). In addition, the distribution destination device 605 performs built-in of the PNP driver while the OS is being started up (process 1023, Step 1505).

In addition, when the start-up of the OS is completed (Step 1506), the operator turns off the distribution destination device 605 and terminates the distribution destination device 605 (process 1024, Step 1507). Therefore, building of a system of the distribution destination device 605 is completed.

As described above, the image 711 may be changed on the basis of the model correspondence image 712 by storing a file of the storage driver or the like, which is difficult to be replaced after the OS of the distribution destination device 605 is started up, in the recording medium before the OS is started up.

In the above-described distribution system, the following effects are obtained.

(1) From the distribution source device 602 that is provided outside the segment 612 to the distribution destination device 605 in the segment 612, image information may be distributed at a high speed as compared with the case of downloading.

(2) The distribution source device 602 may not be provided in the same segment 612 as the distribution destination device 605 and is allowed to be provided in the public cloud 613 on the WAN. Therefore, an administrator (company or the like) of the distribution destination device 605 may not perform preparation of a device and an installation operation for provision of the distribution source device 602 in the segment 612, and the administrator also may not perform maintenance of the distribution source device 602.

When the distribution source device 602 may be provided in the public cloud 613, between two points of LAN or WAN configurations that are independently located, an image of the server is distributed through the Internet, and a duplication server may be built quickly in the event of a disaster or the like. In addition, a server of a company B may be quickly relocated to a data center that is ran by a company A.

In addition, a master image that is generated by the server in the center may be quickly distributed to the plurality of distribution destination devices 605 that are coupled through not a single LAN or WAN. For example, a master image that is generated in the main office may be distributed to point of sales (POS) terminals that are installed in a large number of supermarkets.

(3) The relay device 604 may relay communication without storing communication data in the recording medium other than the memory, so that an image may be distributed using resources that are further smaller than that in the case of downloading. For example, an information processing device having a small disk capacity such as a mobile terminal may be used as the relay device 604.

(4) Even when the model of the distribution destination device 605 is different from the model of the master device 601, the OS may be started up on the distribution destination device 605. When the image may be distributed to the distribution destination device 605 having a different model, for example, a system that operates on an old-type master device 601 may be easily shifted to a new-type distribution destination device 605.

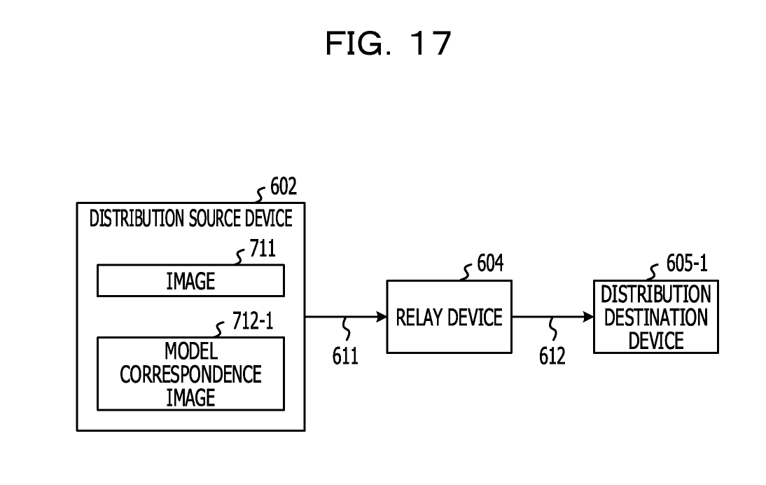

The distribution performance of the distribution system of FIG. 6 is described below with reference to FIGS. 17 to 20.

FIG. 17 is a diagram illustrating a case in which the image 711 and the model correspondence image 712-1 are distributed from the distribution source device 602 to the single distribution destination device 605-1 through the relay device 604. Here, the sizes of the image 711 and the model correspondence image 712-1 are set at 20 gigabyte (GB) and 1 GB, respectively, and the communication speed of the WAN 611 and the communication speed in the segment 612 are set at 10 Mbits/sec (bps) and 1 Gbps, respectively. In addition, a write speed of the recording medium in the distribution destination device 605-1 is set at 200 Mbps.

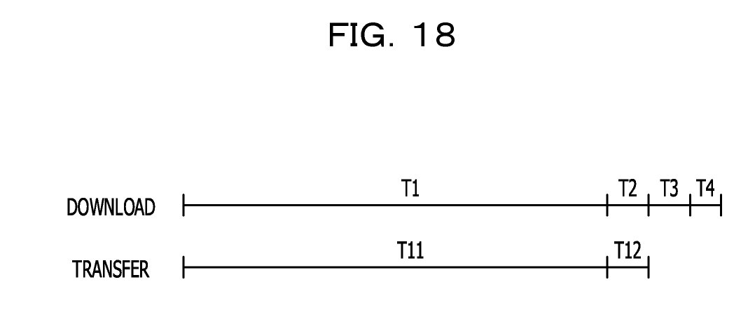

FIG. 18 is a diagram illustrating comparison between a distribution time that is taken when the relay device 604 downloads the image 711 and the model correspondence image 712-1 and a distribution time that is taken when the relay device 604 transfers the image 711 and the model correspondence image 712-1.

When the relay device 604 downloads the image 711 and the model correspondence image 712-1, a time T1 that is taken when the relay device 604 downloads the image 711 from the distribution source device 602 may be calculated as indicated in the following formula.

T1=(20 GB×8-bit)/10 Mbps/60 seconds=about 267 minutes

In addition, a time T2 that is taken when the relay device 604 transmits the downloaded image 711 to the distribution destination device 605-1 is determined on the basis of a write speed of the recording medium and may be calculated as indicated in the following formula.

T2=(20 GB×8-bit)/200 Mbps/60 seconds=about 13 minutes

After that, a time T3 that is taken when the relay device 604 downloads the model correspondence image 712-1 from the distribution source device 602 may be calculated as indicated in the following formula.

T3=(1 GB×8-bit)/10 Mbps/60 seconds=about 13 minutes

In addition, a time T4 that is taken when the relay device 604 transmits the downloaded model correspondence image 712-1 to the distribution destination device 605-1 is determined on the basis of the write speed of the recording medium and may be calculated as indicated in the following formula.

T4=(1 GB×8-bit)/200 Mbps/60 seconds=about 0.7 minutes

Therefore, a distribution time that is taken when the relay device 604 downloads the image 711 and the model correspondence image 712-1 may be calculated as indicated in the following formula.

T1+T2+T3+T4=about 293.7 minutes

In addition, when the relay device 604 transfers the image 711 and the model correspondence image 712-1, a transfer speed from the distribution source device 602 to the distribution destination device 605-1 is determined on the basis of the communication speed of the WAN 611.

In this case, a time T11 that is taken when the relay device 604 transfers the image 711 from the distribution source device 602 to the distribution destination device 605-1 may be calculated as indicated in the following formula.

T11=(20 GB×8-bit)/10 Mbps/60 seconds=about 267 minutes

In addition, a time T12 that is taken when the relay device 604 transfers the model correspondence image 712-1 from the distribution source device 602 to the distribution destination device 605-1 may be calculated as indicated in the following formula.

T12=(1 GB×8-bit)/10 Mbps/60 seconds=about 13 minutes

Therefore, a distribution time that is taken when the relay device 604 transfers the image 711 and the model correspondence image 712-1 may be calculated as indicated in the following formula.

T11+T12=about 280 minutes

As described above, the distribution time that is taken when the relay device 604 transfers the image 711 and the model correspondence image 712-1 is abbreviated by about 13.7 minutes as compared with the distribution time that is taken when the relay device 604 downloads the image 711 and the model correspondence image 712-1.

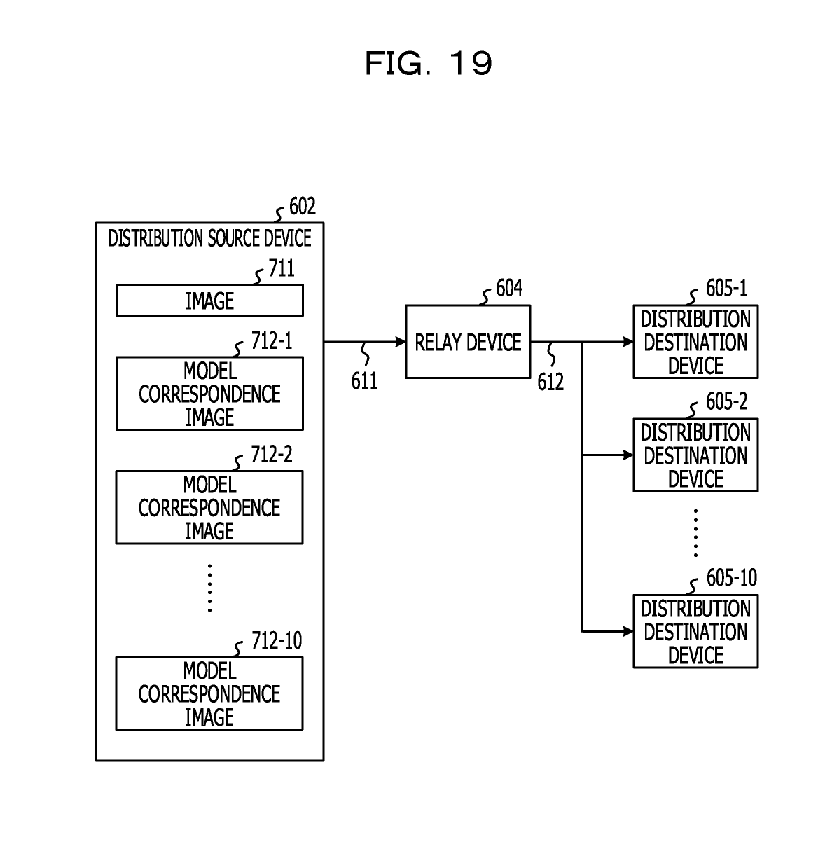

FIG. 19 is a diagram illustrating a case in which the image 711 and the model correspondence images 712-1 to 712-10 are respectively distributed from the distribution source device 602 to the ten distribution destination devices (distribution destination devices 605-1 to 605-10) through the relay device 604. Any size of the model correspondence images 712-1 to 712-10 corresponds to 1 GB. In this case, a communication speed in the segment 612 corresponds to 100 Mbps that is 1/10 of 1 Gbps.

The models of the distribution destination devices 605-1 to 605-10 are different from each other, and the model correspondence images 712-1 to 712-10 are images that correspond to the models of the distribution destination devices 605-1 to 605-10, respectively.

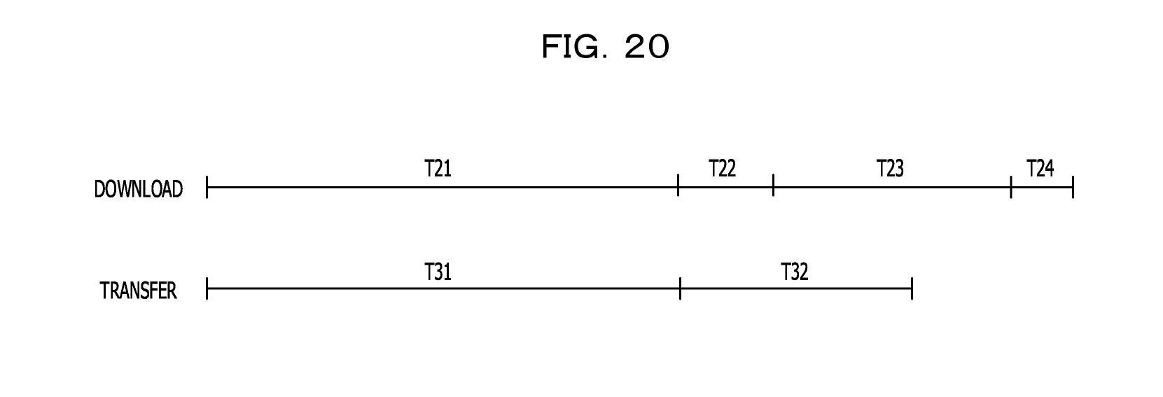

FIG. 20 is a diagram illustrating comparison between a distribution time that is taken when the relay device 604 downloads the image 711 and the model correspondence images 712-1 to 712-10, and a distribution time that is taken when the relay device 604 transfers these images.

When the relay device 604 downloads the image 711 and the model correspondence images 712-1 to 712-10, a time T21 that is taken when the relay device 604 downloads the image 711 from the distribution source device 602 may be calculated as indicated in the following formula.

T21=(20 GB×8-bit)/10 Mbps/60 seconds=about 267 minutes

In addition, a time T22 that is taken when the relay device 604 transmits the downloaded image 711, to the distribution destination devices 605-1 to 605-10 is determined on the basis of the communication speed in the segment 612 and may be calculated as indicated in the following formula.

T22=(20 GB×8-bit)/100 Mbps/60 seconds=about 27 minutes

In addition, a time T23 that is taken when the relay device 604 downloads the model correspondence images 712-1 to 712-10 from the distribution source device 602 may be calculated as indicated in the following formula.

T23=(1 GB×8-bit)/10 Mbps/60 seconds×10 devices=about 133 minutes

In addition, a time T24 that is taken when the relay device 604 transmits the downloaded model correspondence images 712-1 to 712-10, to the distribution destination devices 605-1 to 605-10, respectively is determined on the basis of the communication speed in the segment 612 and may be calculated as indicated in the following formula.

T24=(1 GB×8-bit)/100 Mbps/60 seconds=about 1.3 minutes

Therefore, a distribution time that is taken when the relay device 604 downloads the image 711 and the model correspondence images 712-1 to 712-10 may be calculated as indicated in the following formula.

T21+T22+T23+T24=about 428.3 minutes

When the relay device 604 transfers the image 711 and the model correspondence images 712-1 to 712-10, a transfer speed from the distribution source device 602 to the distribution destination device 605-1 is determined on the basis of the communication speed of the WAN 611.

In this case, a time T31 that is taken when the relay device 604 transfers the image 711 from the distribution source device 602, to the distribution destination devices 605-1 to 605-10 may be calculated as indicated in the following formula.

T31=(20 GB×8-bit)/10 Mbps/60 seconds=about 267 minutes

In addition, a time T32 that is taken when the relay device 604 transfers the model correspondence images 712-1 to 712-10 from the distribution source device 602 to the distribution destination devices 605-1 to 605-10, respectively may be calculated as indicated in the following formula.

T32=(1 GB×8-bit)/10 Mbps/60 seconds×10 devices=about 133 minutes

Therefore, a distribution time that is taken when the relay device 604 transfers the image 711 and the model correspondence images 712-1 to 712-10 may be calculated as indicated in the following formula.

T31+T32=about 400 minutes

As described above, the distribution time that is taken when the relay device 604 transfers the image 711 and the model correspondence images 712-1 to 712-10 is abbreviated by about 28.3 minutes as compared with the distribution time that is taken when the relay device 604 downloads these images. The difference of the distribution times tends to be increased as the number of distribution destination devices 605 is increased, so that it is conceivable that abbreviation effect of the distribution time is increased as the number of distribution destination devices 605 is increased.

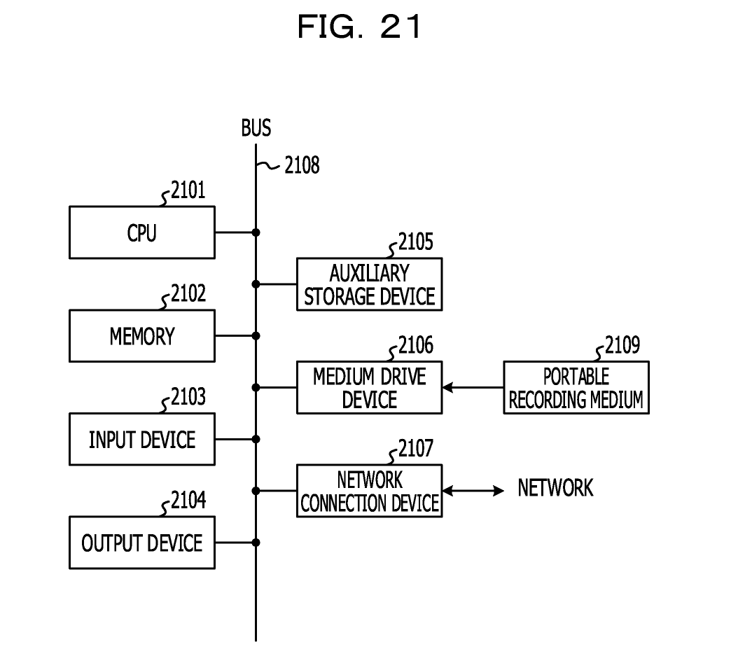

As the master device 601, the distribution source device 602, the relay device 604, and the distribution destination device 605 in FIG. 6, for example, an information processing device (computer) as illustrated in FIG. 21 may be used.

The information processing device of FIG. 21 includes a central processing unit (CPU) 2101, a memory 2102, an input device 2103, an output device 2104, an auxiliary storage device 2105, a medium drive device 2106, and a network connection device 2107. These elements are coupled to each other through a bus 2108.

The memory 2102 includes, for example, a semiconductor memory such as a read only memory (ROM), a random access memory (RAM), and a flash memory, and stores a program and data that are used for the processing.

The CPU 2101 (processor) executes the processing of the master device 601, the distribution source device 602, the relay device 604, or the distribution destination device 605 by executing a program using the memory 2102.

The input device 2103 includes, for example, a keyboard and a pointing device, and is used for an instruction from the user or the operator and an input of information. The output device 2104 includes, for example, a display device, a printer, and a speaker, and is used for inquiry for the user or the operator and an output of the processing result.

The auxiliary storage device 2105 includes, for example, a magnetic disk device, an optical disk device, a magneto optical disk device, and a tape device. The auxiliary storage device 2105 also includes a semiconductor memory such as a hard disk drive and a flash memory. The information processing device stores the program and the data in the auxiliary storage device 2105 and may load the program and the data in the memory 2102 and use the program and the data.

When the information processing device is the master device 601, the auxiliary storage device 2105 may be used as a recording medium that stores one or more files. When the information processing device is the distribution source device 602, the auxiliary storage device 2105 may store the proxy AP 701, the boot image 702, the boot AP 703, the batch file 704, the batch file 705, the image 711, and the model correspondence image 712 in FIG. 7. When the information processing device is the distribution destination device 605, the auxiliary storage device 2105 may be used as a recording medium that stores the distributed image 711 and model correspondence image 712.

The medium drive device 2106 drives a portable recording medium 2109 and accesses the recorded content. The portable recording medium 2109 includes a memory device, a flexible disk, an optical disk, and a magneto optical disk. The portable recording medium 2109 also includes a compact disc read only memory (CD-ROM), a digital versatile disc (DVD), and a Universal Serial Bus (USB) memory The user or the operator may use the program and the data by storing the program and the data in the portable recording medium 2109 and loading the program and the data in the memory 2102.

The computer readable recording medium that stores a program and data that are used for various pieces of processing as described above includes a physical (non-transitory) recording medium such as the memory 2102, the auxiliary storage device 2105, and the portable recording medium 2109.

The network connection device 2107 is a communication interface that is coupled to the communication network of the segment 612 or the WAN 611 and that performs data conversion that is caused by wireless communication or wired communication. The information processing device may also receive a program and data from an external device through the network connection device 2107 and uses the program and the data by loading the program and the data in the memory 2102.

The information processing device may not include all of the configuration elements in FIG. 21, and some of the configuration elements may be omitted depending on the usage and conditions. In addition, when the information processing device is a mobile terminal, a call device such as a microphone and a speaker may be included as the configuration element.

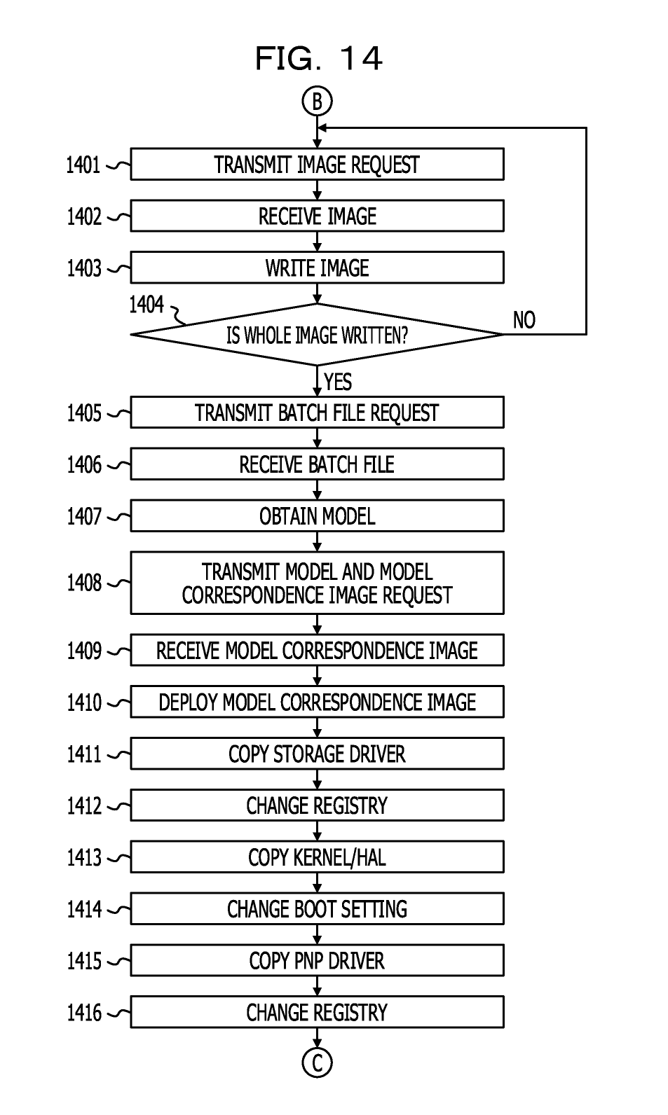

The distribution sequences in FIGS. 8 to 10 and the flowcharts in FIGS. 11 to 15 are merely examples, and some pieces of the processing may be omitted or changed depending on the configurations and conditions of the distribution source device 602, the relay device 604, or the distribution destination device 605. For example, when the model of the distribution destination device 605 is similar to the model of the master device 601, the process 805 in FIG. 8 and the processes 1001 to 1016 in FIG. 10 may be omitted. In this case, the pieces of processing in Steps 1209 to 1212 in FIG. 12 and Steps 1405 to 1416 in FIG. 14 may be also omitted.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A distribution system comprising:
a distribution destination device that includes a first processor and is provided within a certain segment in a communication network;
a distribution source device that includes a second processor and is provided outside the certain segment; and
a relay device that includes a third processor and is provided within the certain segment, wherein
the first processor of the distribution destination device transmits a distribution request that is used to receive image information that includes a file structure having one or more files such that the image information is divided into a plurality of pieces,
the second processor of the distribution source device transmits each of the plurality of divided pieces of the image information in response to the distribution request, and
the third processor of the relay device transfers the distribution request from the distribution destination device to the distribution source device and transfers each of the plurality of divided pieces of the image information from the distribution source device to the distribution destination device.

2. The distribution system according to claim 1, wherein
the third processor of the relay device generates a first address information indicating a host address of the distribution destination device, generates a third address information indicating the distribution destination device based on the first address information and a second address information indicating the certain segment, and transmits the third address information to the distribution destination device, and
the first processor of the distribution destination device transmits the distribution request using the third address information and receives each of the plurality of divided pieces of the image information.

3. The distribution system according to claim 1, wherein
the first processor of the distribution destination device receives each of the plurality of divided pieces of the image information and transmits, to the relay device, a model correspondence distribution request that is used to request model correspondence image information that includes a file that corresponds to a model of the distribution destination device, and
the third processor of the relay device transfers the model correspondence distribution request to the distribution source device and transfers the model correspondence image information that is received from the distribution source device to the distribution destination device.

4. The distribution system according to claim 1, further comprising:
one or more other distribution destination devices that are different from the distribution destination device, wherein
the third processor of the relay device transfers a plurality of distribution requests that are respectively received from the one or more other distribution destination devices to the distribution source device, and respectively transfers the plurality of divided pieces of the image information that are received from the distribution source device, to the one or more other distribution destination devices in response to the plurality of distribution requests.

5. The distribution system according to claim 1, wherein
the third processor of the relay device starts up the distribution destination device.

6. The distribution system according to claim 5, wherein
the second processor of the distribution source device transmits boot image information,
the distribution destination device includes a memory, and
the first processor of the distribution destination device stores the boot image information that is received from the distribution source device in the memory, causes a system to be started up using the boot image information on the memory, and transmits the plurality of distribution requests.

7. The distribution system according to claim 6, wherein
the distribution destination device includes a storage, and
the first processor of the distribution destination device stores the plurality of divided pieces of the image information from the distribution source device in the storage.

8. The distribution system according to claim 1, wherein
the segment is defined by a connection device that couples networks in the communication network, and
the third processor of the relay device receives the plurality of divided pieces of the image information from the distribution source device through the connection device using tunneling and transfers the plurality of divided pieces of the image information to the distribution destination device.

9. A distribution method comprising:
receiving, by a relay device that is provided within the certain segment, a distribution request that is used to receive image information that includes a file structure having one or more files such that the image information is divided into a plurality of pieces, from a distribution destination device that is provided within a certain segment in a communication network;
transferring, by the relay device, the distribution request to a distribution source device that is provided outside the certain segment;
transmitting, by the distribution source device, each of the plurality of divided pieces of the image information to the relay device in response to the distribution request; and
receiving, by the relay device, each of the plurality of divided pieces of the image information from the distribution source device and transferring each of the plurality of divided pieces of the image information to the distribution destination device.

10. The distribution method according to claim 9, further comprising:
generating, by the relay device, a first address information indicating a host address of the distribution destination device;
generating, by the relay device, a third address information indicating the distribution destination device based on the first address information and a second address information indicating the certain segment;
transmitting, by the relay device, the third address information to the distribution destination device;
transmitting, by the distribution destination device, the distribution request using the third address information; and
receiving, by the distribution destination device, each of the plurality of divided pieces of the image information.

11. The distribution method according to claim 9, further comprising:
receiving, by the distribution destination device, each of the plurality of divided pieces of the image information;
transmitting, by the distribution destination device, to the relay device, a model correspondence distribution request that is used to request model correspondence image information that includes a file that corresponds to a model of the distribution destination device;
transferring, by the relay device, the model correspondence distribution request to the distribution source device; and
transferring, by the relay device, the model correspondence image information that is received from the distribution source device to the distribution destination device.

12. The distribution method according to claim 9, further comprising:
transferring, the relay device, a plurality of distribution requests that are respectively received from one or more other distribution destination devices to the distribution source device, the one or more other distribution destination devices being different from the distribution destination device; and
respectively transferring, by the relay device, the plurality of divided pieces of the image information that are received from the distribution source device, to the one or more other distribution destination devices in response to the plurality of distribution requests.

13. The distribution method according to claim 9, further comprising:
starting up, by the relay device, the distribution destination device.

14. The distribution method according to claim 13, further comprising:
transmitting, the distribution source device, boot image information;
storing, by the distribution destination device, the boot image information that is received from the distribution source device in a memory in the distribution destination device;
causing, by the distribution destination device, a system to be started up using the boot image information on the memory; and
transmitting, by the distribution destination device, the plurality of distribution requests.

15. The distribution method according to claim 14, further comprising:
storing, by the distribution destination device, the plurality of divided pieces of the image information from the distribution source device in the storage in the distribution destination device.

16. The distribution method according to claim 9, further comprising:
defining, by a connection device that couples networks in the communication network, the segment;
receiving, by the relay device, the plurality of divided pieces of the image information from the distribution source device through the connection device using tunneling; and
transferring, by the relay device, the plurality of divided pieces of the image information to the distribution destination device.

17. A non-transitory computer-readable recording medium storing a program causing a computer within a certain segment in a communication network to execute a process, the process comprising:
receiving a distribution request that is used to receive image information that includes a file structure having the one or more files such that the image information is divided into a plurality of pieces, from the distribution destination device that is provided within the certain segment;
transferring the distribution request to a distribution source device that is provided outside the certain segment; and
receiving each of the plurality of divided pieces of the image information from the distribution source device in response to the distribution request and transferring each of the plurality of divided pieces of the image information to the distribution destination device.
